(19) United States
(12) Patent Application Publication
(10) Pub. No.: US 2016/0375862 A1
(43) Pub. Date: Dec. 29, 2016

(54) AUTONOMOUS TRAVELING APPARATUS

(71) Applicant: Sharp Kabushiki Kaisha, Osaka (JP)

(72) Inventors: Tetsushi ITO, Osaka (JP); Haruo YAMAMOTO, Osaka (JP); Kyosuke TAKA, Osaka (JP)

(21) Appl. No.: 15/072,700

(22) Filed: Mar. 17, 2016

(30) Foreign Application Priority Data
Jun. 29, 2015 (JP) 2015-129923

(51) Int. Cl. B60R 25/10; B60R 25/30; B60R 1/00; G05D 1/00

(52) U.S. Cl. CPC B60R 25/1004; G05D 1/0088; B60R 25/305; B60R 25/30; B60R 1/00

(57) ABSTRACT

This invention is an autonomous traveling apparatus having a traveling control part for controlling a driving member; an imaging part for photographing an image data of a predetermined external space; an image recognition part for extracting a human body included in the image data photographed by the imaging part, and recognizing an image data of the extracted human body; a sensor for preventing theft; and a controller for executing operation in emergency corresponding to a recognition result by the image recognition part, and a detection result by the sensor for preventing theft.

### BACKGROUND OF THE INVENTION

1. Field of the Invention

The present invention relates to an autonomous traveling apparatus, and more particularly to an autonomous traveling apparatus for automatically performing monitoring operation outdoors or the like, in an unmanned state.

2. Description of the Related Art

In these days, autonomous traveling apparatuses that autonomously move, such as monitoring robots that monitor situation inside a building, around a building, and inside predetermined premises, are utilized. Such conventional autonomous traveling apparatuses each include a camera, a distance image sensor, and the like, and travel on a predetermined route in an unmanned state, or autonomously travel based on remote operation by a person in charge, while acquiring monitoring information such as image data.

When the autonomous traveling apparatus performs the monitoring operation, there is generally no person near the autonomous traveling apparatus, namely, the autonomous traveling apparatus is in an unmanned state. Therefore, there is a risk that the camera or the autonomous traveling apparatus itself is destroyed, or acquired monitoring data or the apparatus itself is stolen. Accordingly, also in the conventional autonomous traveling apparatus, various theft countermeasures and intrusion prevention countermeasures to a suspicious person are proposed.

For example, in JP 2010-72831 A, there is proposed a security robot that, in a case where an intrusion detection sensor detects that a suspicious person has intruded in a monitoring area, informs a person in a security management room of intrusion of the suspicious person, is made to move in a direction of the suspicious person by radio control by a monitoring person, and outputs intimidation voice to the suspicious person by operation by the monitoring person. In a case where it is determined based on a content of a transmission image or a level change of a detection signal of an acceleration sensor that the suspicious person is making an attack, the security robot makes an attack such as electric shocks to the suspicious person.

Additionally, in JP H09-330484 A, there is proposed an anti-theft apparatus for a mobile robot that includes a distance sensor for measuring a distance between a robot and a ground, and gives an alarm by generation of alarm sound, transmission of an alarm signal, or the like, in a case where it is detected that the robot is separated from the ground.

Furthermore, in JP 2008-152659 A, there is proposed an anti-theft autonomous mobile robot that holds map information of an area where autonomous movement is to be performed, calculates a difference between a current location (GPS) acquired from a GPS and a current location (MAP) acquired from a relative moving distance calculated by using a wheel sensor and the map information, and makes a notification to a prescribed contact address, generates an alarm, erases or encrypts internal data, and destroys a component, in a case where it is determined that the current location (MAP) is not in a prescribed area.

However, in the conventional autonomous traveling apparatuses, in a case where a person presumed to be a suspicious person is detected, it is difficult to prevent destruction or theft of the apparatus by merely performing intimidation operation of generating alarm sound or light. Additionally, even when a predetermined attack is made to a suspicious person in addition to the intimidation as in JP 2010-72831 A, in a case where a destructive attack using a gun or the like is made, it is difficult to prevent theft of stored monitoring data, or take out the monitoring data.

Additionally, in JP H09-330484 A, when the attack that has been made to the robot is accompanied by external change such as the separation of the robot from the ground, the attack can be detected. However, there are some cases where internal destruction which is not accompanied by external change, or theft of stored monitoring data cannot be detected, and the theft of the monitoring data cannot be prevented by merely generating alarm sound or transmitting an alarm.

Furthermore, in JP 2008-152659 A, an effective countermeasure can be performed to such theft as taking of the robot itself away. However, in a case where a current location of the robot is not abnormal, but internal destruction or theft of the monitoring data is performed without separating the robot from a floor surface, there are some cases where occurrence of a trouble cannot be detected, and an effective countermeasure cannot be taken.

In a case where occurrence of a trouble is detected, even when leakage of important information or the like can be prevented by erasure or encryption of internal data, or destruction of a component, there are some cases where monitoring data stored right before the occurrence of the trouble cannot be confirmed afterward in a case where the internal data is erased.

Additionally, in a case where a person is detected, there are some cases where the person is not a suspicious person. Therefore, even when a person approaches the autonomous traveling apparatus, there are some cases where intimidation operation or the like is not suitable.

### SUMMARY OF THE INVENTION

The present invention has been made in view of the aforementioned circumstances, and an object of the present invention is to provide an autonomous traveling apparatus that promptly implements a suitable countermeasure among several countermeasures such as intimidation operation, based on predetermined information acquired from a camera or the like.

The present invention provides an autonomous traveling apparatus including: a traveling control part for controlling a driving member; an imaging part for photographing an image data of a predetermined external space; an image recognition part for extracting a human body included in the image data photographed by the imaging part, and recognizing an image data of the extracted human body; a sensor for preventing theft; and a controller for executing operation in emergency corresponding to a recognition result by the image recognition part, and a detection result by the sensor for preventing theft.

Further, the sensor for preventing theft may be a vibration detection part for detecting externally applied vibration.

### BRIEF DESCRIPTION OF THE DRAWINGS

FIG. 1 is an appearance diagram of an embodiment of an autonomous traveling apparatus of the present invention;

FIGS. 2A and 2B each are an explanatory diagram of a configuration related to traveling of the autonomous traveling apparatus of the present invention;

FIG. 3 is a configuration block diagram of an embodiment of the autonomous traveling apparatus of the present invention;

FIGS. 4A and 4B each are a schematic explanatory diagram of an embodiment of information to be stored in a storage part;

FIGS. 5A and 5B each are an explanatory diagram of an embodiment of a correspondence relation between detection items and operation in emergency of the present invention;

FIG. 6 is a schematic explanatory diagram of an embodiment of a distance detection part of the present invention;

FIG. 7 is a schematic explanatory diagram of a scanning direction of a laser emitted from the distance detection part of the present invention; and

FIGS. 8A and 8B each are a schematic explanatory diagram in which an irradiation area of a laser of the present invention is viewed from above and from back.

### DETAILED DESCRIPTION OF THE PREFERRED EMBODIMENTS

The present invention provides an autonomous traveling apparatus including: a traveling control part for controlling a driving member; an imaging part for photographing an image data of a predetermined external space; an image recognition part for extracting a human body included in the image data photographed by the imaging part, and recognizing an image of the extracted human body; a sensor for preventing theft; and a controller for executing operation in emergency corresponding to a recognition result by the image recognition part, and a detection result by the sensor for preventing theft.

Further, the sensor for preventing theft may be a vibration detection part for detecting externally applied vibration.

The autonomous traveling apparatus further includes a storage part. In the autonomous traveling apparatus, person registration information in which image data of an authentic person is registered is previously stored in the storage part, and in a case where the image recognition part compares a human body image included in the image data photographed by the imaging part with the person registration information stored in the storage part, and the human body image and the person registration information do not coincide with each other, the controller executes an intimidation process of outputting a warning to the photographed human body, as the operation in emergency, and executes a notification process of notifying a person in charge at a location different from a location of the autonomous traveling apparatus that an abnormal state occurs.

In this configuration, in a case where it is determined that the human body photographed by the image recognition does not coincide with the previously registered authentic person, the operation in emergency is executed. Therefore, predetermined operation in emergency is performed in a case where a recognized person is a suspicious person, and the operation in emergency is not performed in a case where the recognized person is an authentic person.

The autonomous traveling apparatus further includes a monitoring information acquisition part that acquires information of a predetermined object to be monitored. In the autonomous traveling apparatus, saving information including monitoring information acquired from the object to be monitored, and setting information necessary for executing a predetermined function, is stored in the storage part, and in a case where image data that is capable of coinciding with the human body image included in the photographed image data does not exist in the person registration information stored in the storage part, and the vibration detection part detects that vibration is externally applied, the controller executes the intimidation process, the notification process, and a saving process of transmitting the saving information stored in the storage part to a management server disposed at a location different from a location of the autonomous traveling apparatus, as the operation in emergency.

In this configuration, the saving process for saving information stored in the storage part is executed, and therefore reuse or restoring of the saving information is possible, and a situation and the like just before a fraudulent action can also be analyzed.

In the autonomous traveling apparatus, in a case where the vibration detection part detects that vibration is continuously applied for a certain period or more, the controller executes the intimidation process, the notification process, the saving process, and an erasure process of erasing the saving information stored in the storage part, as the operation in emergency.

In this configuration, the process of erasing the saving information stored in the storage part is executed, and therefore it is possible to prevent fraudulent use of the saving information, and to prevent leakage of important secret information and the like.

In the autonomous traveling apparatus, in a case where the vibration detection part detects that vibration is continuously applied for a certain period or more in a state where the autonomous traveling apparatus is at a stop, the controller executes a destruction process of destroying a predetermined component of the autonomous traveling apparatus, after executing the saving process.

In this configuration, the process of destroying a component of the autonomous traveling apparatus is executed, and therefore even when the autonomous traveling apparatus is stolen, it is possible to prevent execution of a predetermined configuration or function, and also to prevent resale or the like of the autonomous traveling apparatus.

Additionally, the autonomous traveling apparatus further includes a communication part that performs wireless communication through a network. In a case where the notification process is executed, the communication part transmits notification information including occurrence of the abnormal state, an occurrence date, and an occurrence location, to at least one of a management server disposed at a location different from a location of the autonomous traveling apparatus and a terminal possessed by the person in charge.

Hereinafter, embodiments of the present invention will be described with reference to drawings. The present invention is not limited to the following description of the embodiments.

### <Configuration of Autonomous Traveling Apparatus>

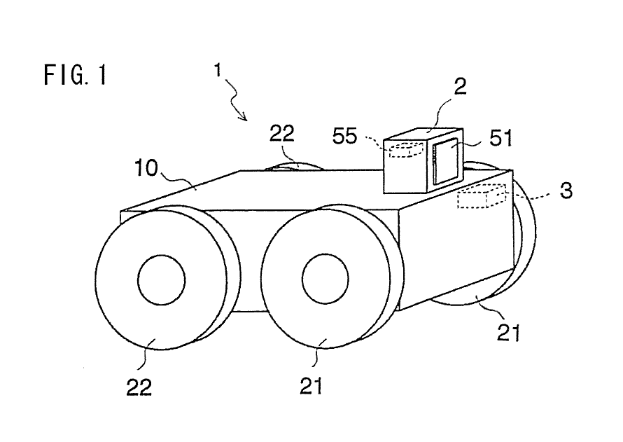

FIG. 1 is an appearance diagram of an embodiment of an autonomous traveling apparatus of the present invention.

In FIG. 1, an autonomous traveling apparatus 1 of the present invention is a vehicle having a function of autonomously moving while avoiding obstacles based on predetermined route information.

Additionally, the autonomous traveling apparatus 1 may have various functions such as a transport function, a monitoring function, a cleaning function, a guide function, and a notification function, in addition to the moving function.

In the following embodiment, an autonomous traveling apparatus capable of autonomously traveling on a predetermined outdoor monitoring area or passage, monitoring a monitoring area and the like, or transporting is mainly described.

In the appearance diagram of FIG. 1, the autonomous traveling apparatus 1 (hereinafter, also referred to as a vehicle) mainly includes a vehicle body 10, four wheels (21, 22), a monitoring unit 2, and a control unit 3.

The monitoring unit 2 is a part having a function of confirming states of an area and a road surface where the autonomous traveling apparatus moves, and a function of monitoring an object to be monitored. The monitoring unit 2 is configured from, for example, a distance detection part 51 that confirms a state of a front space where the autonomous traveling apparatus moves, a camera (imaging part) 55, a vibration detection part 57, and a location information acquisition part 60 that acquires information of a current location where the autonomous traveling apparatus is being traveling.

The control unit 3 is a part that executes a traveling function, a monitoring function, and the like of the autonomous traveling apparatus of the present invention. The control unit 3 is configured from, for example, a controller 50, an image recognition part 56, a monitoring information acquisition part 59, a communication part 54, an information saving part 62, an intimidation execution part 63, and a storage part 70, which are described later.

The autonomous traveling apparatus of the present invention self-travels while confirming a state of a front space in an advancing direction of the vehicle body 10 by particularly utilizing the camera 55, the distance detection part 51, the vibration detection part 57, and the like. For example, in a case where it is detected that an obstacle, a difference in level, or the like exists at the front, operation such as standstill, rotation, retreat and advance is performed and a course is changed, in order to prevent collision with the obstacle. In a case where a suspicious person is recognized by an image, or in a case where abnormal vibration is detected, a predetermined function corresponding to a detection item, among operation in emergency including intimidation operation and the like, is executed.

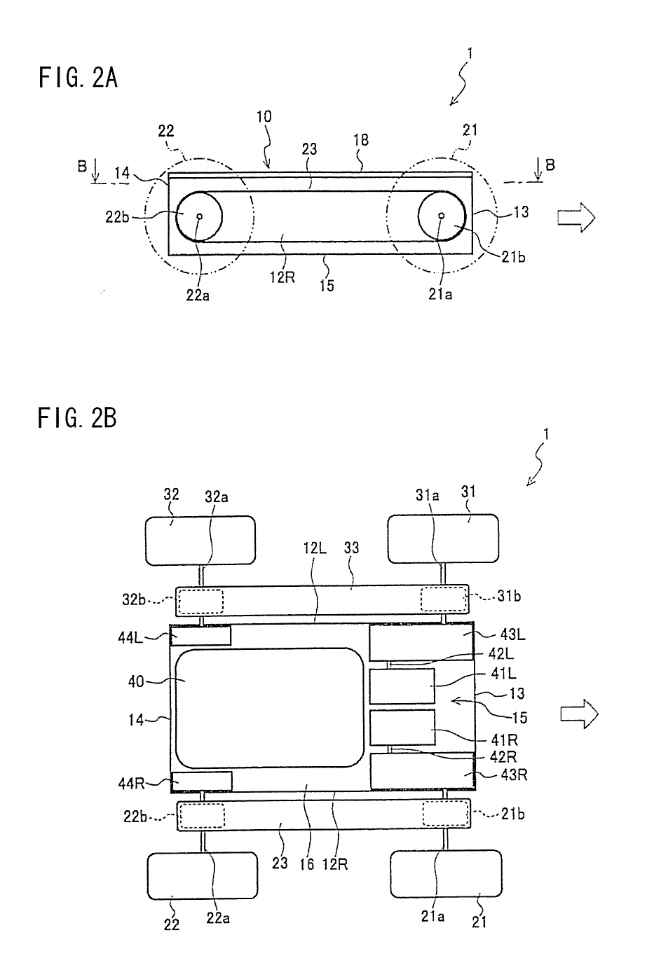

FIGS. 2A and 2B each are an explanatory diagram of a configuration related to traveling of the autonomous traveling apparatus of the present invention.

FIG. 2A is a right side view of the vehicle 1, and illustrates a right front wheel 21 and a right rear wheel 22 by virtual lines. FIG. 2B is a sectional view taken along a B-B line arrow of FIG. 2A, and illustrates later-described sprockets 21b, 22b, 31b, 32b by virtual lines. Front wheels (21, 31) are disposed on a front surface 13 of the vehicle body 10, and rear wheels (22, 32) are disposed on a rear surface 14 thereof.

A belt-shaped cover 18 is installed on each of side surfaces 12R, 12L of the vehicle body 10, and extends along a front-rear direction of the vehicle body 10. On a lower side of the cover 18, axles 21a, 31a and axles 22a, 32a that rotatably support the front wheels 21, 31 and the rear wheels 22, 32, respectively, are provided. Each of the axles 21a, 31a, 22a, 32a is independently rotatable in a case where the axles 21a, 31a, 22a, 32a are not coupled by power transmission members.

The right and left pairs of the front wheels (21, 31) and rear wheels (22, 32) are provided with belts 23, 33 that are the power transmission members, respectively. More specifically, the axle 21a of the right front wheel 21 is provided with the sprocket 21b, and the axle 22a of the rear wheel 22 is provided with the sprocket 22b. Additionally, for example, the belt 23 provided with projections, which mesh with the sprocket, on an inner surface side, is wound between the sprocket 21b of the front wheel and the sprocket 22b of the rear wheel. Similarly, the axle 31a of the left front wheel 31 is provided with the sprocket 31b, and the axle 32a of the rear wheel 32 is provided with the sprocket 32b. The belt 33 having the same structure as the belt 23 is wound between the sprocket 31b of the front wheel and the sprocket 32b of the rear wheel.

Accordingly, the pairs of the front wheels and the rear wheels (21 and 22, 31 and 32) on the right and left are coupled and driven by the belts (23, 33), and therefore, only one of the wheels has to be driven. For example, the front wheels (21, 31) have to be driven. In a case where one of the pairs of the wheels is used as driving wheels, the other wheels function as driven wheels that are driven without slipping by the belt that is the power transmission member.

As the power transmission member that couples and drives each of the pairs of the front wheels and the rear wheels on the right and left, for example, a sprocket, and a chain that meshes with this sprocket may be used, in addition to a sprocket and a belt provided with projections that mesh with this sprocket. Furthermore, in a case where slip is allowable, a pulley and a belt having large friction may be used as the power transmission member. However, the power transmission member is configured such that the number of rotations of the driving wheel is made to be the same as the number of rotations of the driven wheel.

In FIGS. 2A and 2B, the front wheels (21, 31) correspond to the driving wheels, and the rear wheels (22, 32) correspond to the driven wheels.

Two motors, namely an electric motor 41R for driving the right front and rear wheels 21, 22, and an electric motor 41L for driving the left front and rear wheels 31, 32 are provided on a front wheel side of a bottom surface 15 of the vehicle body 10. A gear box 43R as a power transmission mechanism is provided between a motor shaft 42R of the right electric motor 41R and the axle 21 a of the right front wheel 21. Similarly, a gear box 43L as the power transmission mechanism is provided between a motor shaft 42L of the left electric motor 41L and the axle 31a of the left front wheel 31. Herein, the two electric motors 41R, 41L are disposed in parallel so as to be bilaterally symmetrical with respect to a centerline in the advancing direction of the vehicle body, and the gear boxes 43R, 43L are disposed on right and left outsides of the electric motors 41R, 41L, respectively.

Each of the gear boxes 43R, 43L is configured by a plurality of gears, a shaft, and the like, and is an assembly part that changes torque, the number of rotations, or a rotation direction to transmit power from the electric motor to an axle that is an output shaft. The gear boxes 43R, 43L may include a clutch that switches the power between transmission and interruption. The right and left rear wheels 22, 32 are supported by bearings 44R, 44L, respectively, and the bearings 44R, 44L are disposed adjacent to a right side surface 12R and a left side surface 12L of the bottom surface 15 of the vehicle body 10, respectively.

With the above configuration, a pair of the front and rear wheels 21, 22 on the right side in the advancing direction, and a pair of the front and rear wheels 31, 32 on the left side can independently drive. That is, power of the right electric motor 41R is transmitted to the gear box 43R through the motor shaft 42R, and the gear box 43R changes the number of rotations, torque or a rotation direction to transmit the power to the axle 21a. Then, the wheel 21 is rotated by rotation of the axle 21a, and the rotation of the axle 21a is transmitted to the axle 22a through the sprocket 21b, the belt 23, and the sprocket 22b, thereby rotating the rear wheel 22. Transmission of power from the left electric motor 41L to the front wheel 31 and the rear wheel 32 is similar to the above operation of the right side.

In a case where the numbers of rotations of the two electric motors 41R, 41L are the same, when the respective gear ratios (reduction ratios) of the gear boxes 43R, 43L are made to be the same, the autonomous traveling apparatus 1 travels forward or rearward. In a case where a speed of the autonomous traveling apparatus 1 is changed, the speed is required to be changed while the respective gear ratios of the gear boxes 43R, 43L are maintained at the same value.

For changing the advancing direction, the respective gear ratios of the gear boxes 43R, 43L are required to be changed to make the numbers of rotations of the right front wheel 21 and the right rear wheel 22 different from the numbers of rotations of the left front wheel 31 and the left rear wheel 32. Furthermore, rotation directions of the right and left wheels can be made opposite by changing a rotation direction of output from each of the gear boxes 43R, 43L, so that stationary turn with a vehicle body central part as the center is made possible.

In a case where the autonomous traveling apparatus 1 is made to stationarily turn, since a steering mechanism that can vary angles of front and rear wheels is not provided, the larger the interval between the front and rear wheels (wheel base) is, the larger the resistance applied to each wheel is. Accordingly, large driving torque for turn is needed. However, since the gear ratio of inside of each of the gear boxes 43R, 43L is variable, large torque can be applied to the wheels by merely reducing the numbers of rotations of the wheels during turn.

For example, in a case where as the gear ratios of the inside of the gear box 43R, the number of teeth of a gear on the motor shaft 42R side is 10, the number of teeth of an intermediate gear is 20, and the number of teeth of a gear on the axle 21b side is 40, the number of rotations of the axle 21b is one fourth of the number of rotations of the motor shaft 42R, but torque of four times is obtained. When a gear ratio at which the number of rotations is further reduced is selected, larger torque can be obtained. Therefore, the autonomous traveling apparatus 1 can turn even on a road surface having large resistance applied to wheels, such as an irregular ground and sandy soil.

The gear boxes 43R, 43L are provided between the motor shaft 42R, 42L and the axle 21a, 31a, and therefore vibration from the wheels 21, 31 is never directly transmitted to the motor shafts. Furthermore, it is desirable that a clutch that performs transmission and cutting-off (interruption) of power to the gear boxes 43R, 43L is provided, and power transmission between the electric motors 41R, 41L and the axles 21a, 31a serving as driving shafts is interrupted during non-conduction of the electric motors 41R, 41L. Consequently, even if power is applied to the vehicle body 10 at stoppage and the wheels rotate, the rotation is not transmitted to the electric motors 41R, 41L. Therefore, counter electromotive force is not generated in the electric motors 41R, 41L, and there is no fear that circuits of the electric motors 41R, 41L are damaged.

Thus, each of the pairs of the front wheels and the rear wheels on the right and left is coupled by the power transmission member, and the two electric motors disposed on the front wheel can drive the four wheels. Therefore, it is not necessary to provide electric motors dedicated for a rear wheel, and gear boxes dedicated for a rear wheel between the electric motors and the rear wheels, and it is possible to reduce installation spaces of the electric motors and the gear boxes dedicated for a rear wheel.

As described above, the two electric motors 41R, 41L are disposed right and left in the advancing direction, on sides close to the front wheels 21, 31 of the bottom surface 15 of the vehicle body 10, and the gear boxes 43R, 43L are disposed on right and left sides of the electric motors 41R, 41L, respectively. However, only the bearings 44R, 44L are disposed on sides close to the rear wheels 22, 32 of the bottom surface 15, and therefore a wide housing space 16 can be secured on the bottom surface 15 of the vehicle body 10 from a central position of the bottom surface to, for example, a rear end of the vehicle body.

A battery (rechargeable battery) 40 such as a lithium-ion battery is employed as a power source of each of the electric motors 41R, 41L, and installed in the housing space 16. More specifically, the battery 40 has an outer shape of, for example, a rectangular parallelepiped, and can be placed at a substantially central position of the bottom surface 15 as illustrated in FIG. 2B. Additionally, the rear surface 14 of the vehicle body 10 is desirably configured to be openable with respect to, for example, an upper surface or the bottom surface 15, so that the battery 40 is easily taken in/out of the housing space 16.

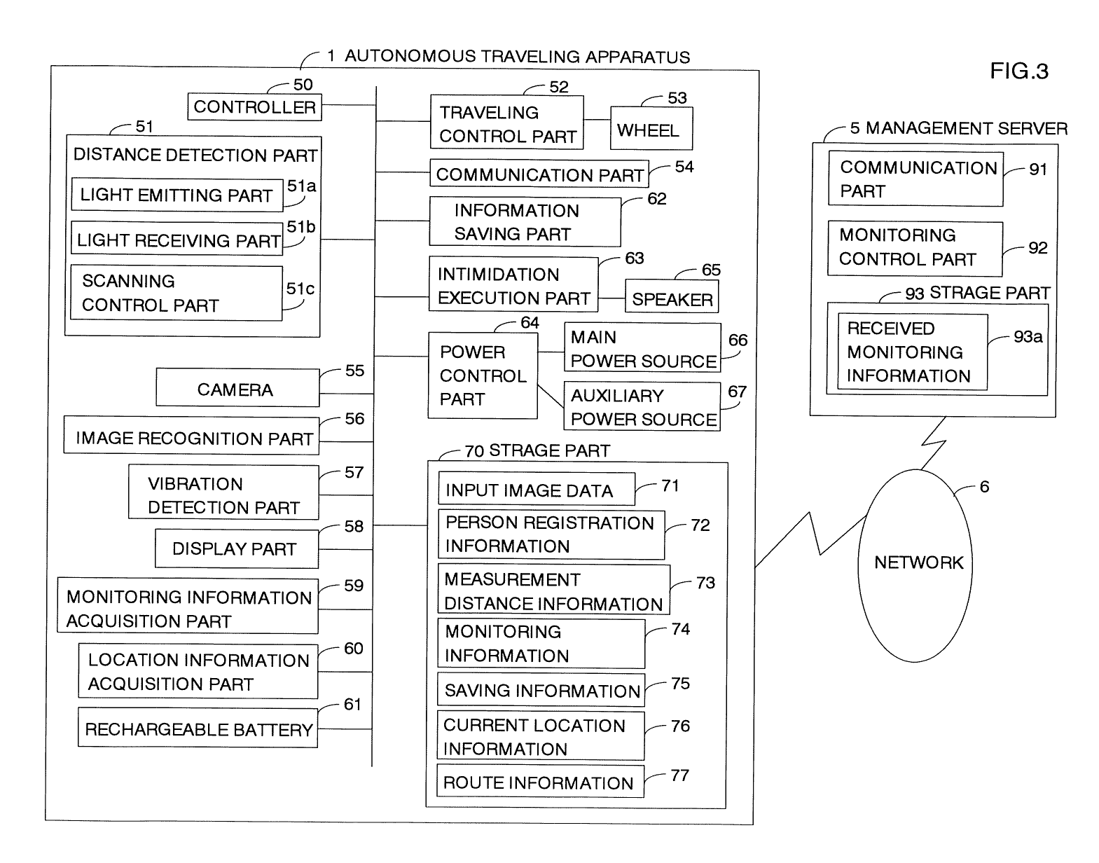

Consequently, a large capacity battery 40 for implementing long-time traveling can be mounted in the housing space 16 of the vehicle body 10, and work such as replacement, charge, and inspection of the battery 40 can be easily performed from the rear surface 14. Furthermore, the battery 40 can be disposed on the bottom surface 15, and therefore it is possible to obtain an electrically driven vehicle that has the vehicle body 10 with low center of gravity, and is capable of stably traveling. FIG. 3 is a configuration block diagram of an embodiment of the autonomous traveling apparatus of the present invention.

In FIG. 3, an autonomous traveling apparatus 1 of the present invention mainly includes a controller 50, a distance detection part 51, a traveling control part 52, wheels 53, a communication part 54, a camera 55, an image recognition part 56, a vibration detection part 57, a display part 58, a monitoring information acquisition part 59, a location information acquisition part 60, a rechargeable battery 61, an information saving part 62, an intimidation execution part 63, a power control part 64, a speaker 65, a main power source 66, an auxiliary power source 67, and a storage part 70.

The autonomous traveling apparatus 1 is connected to a management server 5 through a network 6, autonomously travels base on instruction information sent from the management server 5, and transmits acquired monitoring information, saving information, and the like to the management server 5.

Any network currently utilized can be utilized as the network 6. However, since the autonomous traveling apparatus 1 is a moving apparatus, utilization of a network capable of performing wireless communication (e.g., wireless LAN) is preferable.

As the wireless communication network, the Internet that is open to public or the like may be utilized, or a wireless network of a dedicated line which restricts a connectable apparatus may be utilized. Examples of a wireless transmission system in a wireless communication channel include methods in compliance with standards of various wireless LAN (Local Area Network) (regardless of the presence/absence of the WiFi (registered trademark) authentication), ZigBee (registered trademark), Bluetooth (registered trademark) LE (Low Energy), and the like. Any wireless transmission system can be used in consideration of a radio reachable area, a transmission band, and the like. For example, a mobile phone network may be utilized.

The management server 5 mainly includes a communication part 91, a monitoring control part 92, and a storage part 93. The communication part 91 is a part that communicates with the autonomous traveling apparatus 1 through the network 6, and preferably has a wireless communication function.

The monitoring control part 92 is a part that causes execution of movement control to the autonomous traveling apparatus 1, an information collecting function and a monitoring function of the autonomous traveling apparatus 1, and the like.

The storage part 93 is a part that stores information for making a movement instruction to the autonomous traveling apparatus 1, the monitoring information (received monitoring information 93a) or the saving information sent from the autonomous traveling apparatus 1, a program for monitoring control, and the like.

The controller 50 of the autonomous traveling apparatus 1 is a part that controls operation of each component such as the traveling control part 52, and is mainly implemented by a microcomputer configured from a CPU, a ROM, a RAM, an I/O controller, a timer, and the like.

The CPU organically operates various hardware based on a control program previously stored in the ROM or the like to execute a traveling function, an image recognition function, a vibration detection function, an information saving function, and the like of the present invention.

In the present invention, as described later, the controller 50 particularly causes the image recognition part 56 to recognize an image of a person, causes the vibration detection part 57 to detect vibration applied to the vehicle, and causes execution of operation in emergency corresponding to a recognition result of the image and a detection result of the vibration.

The distance detection part 51 is a part that detects a distance from a current location of the vehicle to an object and a road surface existing in a front space in the advancing direction. Herein, in a case where the vehicle travels outdoors, the object means, for example, a building, a pole, a wall, or a projection.

The distance detection part 51 emits predetermined light to a front space in a traveling direction, thereafter receives reflected light reflected by the object and the road surface existing in the front space, and detects a distance to the object and the road surface. More specifically, the distance detection part 51 is mainly configured from a light emitting part 51a that emits light, a light receiving part 51b that receives light reflected by the object, and a scanning control part 51c that two-dimensionally or three-dimensionally changes an emission direction of light.

The distance detection part 51 can be used for the above-mentioned sensor for preventing theft.

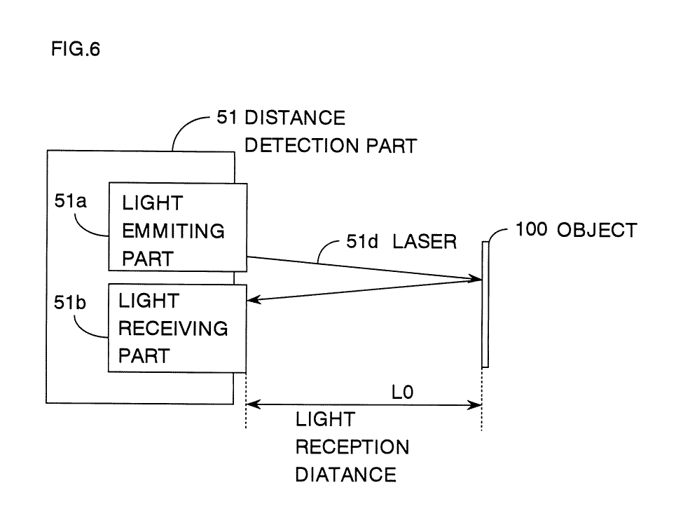

FIG. 6 is an explanatory diagram of an embodiment of the distance detection part 51 of the present invention.

Herein, a laser 51d emitted from the light emitting part 51a is reflected on an object 100, and a part of the laser that reciprocates and returns by a light reception distance L0 is received by the light receiving part 51b.

As light to be emitted, a laser, an infrared ray, visible light, an ultrasonic wave, an electromagnetic wave, and the like can be used. However, the light should be sufficiently capable of distance measurement even at night, and therefore the laser is preferably used.

A LIDAR (Light Detection and Ranging or Laser Imaging Detection and Ranging) is currently used as a distance detection sensor, and may be used as the distance detection part 51.

The LIDAR is an apparatus that emits a laser to a two-dimensional space or a three-dimensional space within a predetermined distance measurement area, and measures a distance at a plurality of measurement points in the distance measurement area.

Additionally, after emitting the laser from the light emitting part 51a, the LIDAR detects reflected light reflected on the object by the light receiving part 51b and calculates the light reception distance L0 from, for example, a time difference between an emitting time and a light receiving time. This light reception distance L0 corresponds to measurement distance information 73 described later.

Assuming that a laser emitted from the light emitting part 51a hits on a stationary object separated by the distance L0, the laser advances by a distance (2L0) equivalent to twice the distance L0 from a tip of the light emitting part 51a to an object surface, and is received by the light receiving part 51b.

The laser emitting time is deviated from the light receiving time by a time T0 required for the laser to advance by the above distance (2L0). That is, a time difference occurs, and the above light reception distance L0 can be calculated by utilizing this time difference T0 and a speed of the light.

FIG. 6 illustrates a case where the distance detection part 51 is not moved, and illustrates a case where a laser emitted from the light emitting part 51a advances the same optical path.

Accordingly, in a case where reflected light that hits on one point of the object 100 and is reflected is received, only a distance between the tip of the light emitting part 51a and the one point of the object is calculated.

The scanning control part 51c is a part that performs scanning in an emitting direction of light so as to emit the light toward a plurality of predetermined measurement points in the front space in a traveling direction. The scanning control part 51c changes a direction of the distance detection part 51 little by little at every certain period interval, thereby moving on an optical path, where the emitted laser advances, little by little.

The LIDAR 51 changes the emitting direction of the laser by a predetermined scanning pitch, in a range of a predetermined horizontal two-dimensional space, and calculates a distance to the object (horizontal two-dimensional scanning). Additionally, in a case where a distance is three-dimensionally calculated, the emitting direction of the laser is changed in a vertical direction by a predetermined scanning pitch, and the above horizontal two-dimensional scanning is further performed, so that the distance is calculated.

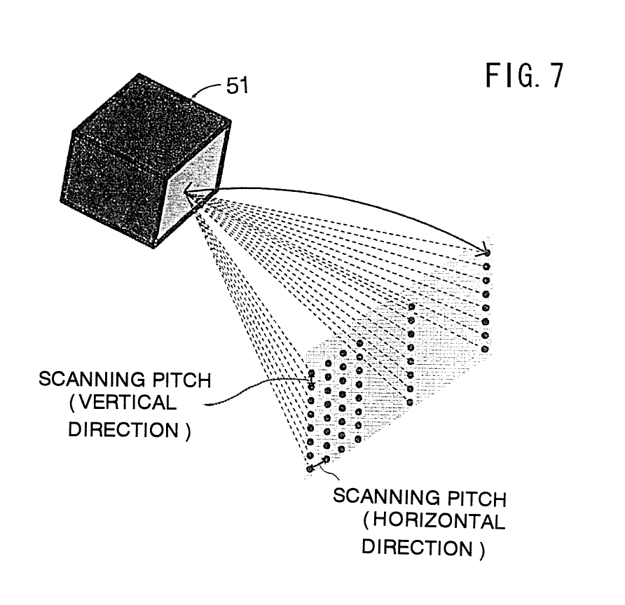

FIG. 7 illustrates a schematic explanatory diagram of the scanning direction of the laser emitted from the distance detection part (LIDAR) 51.

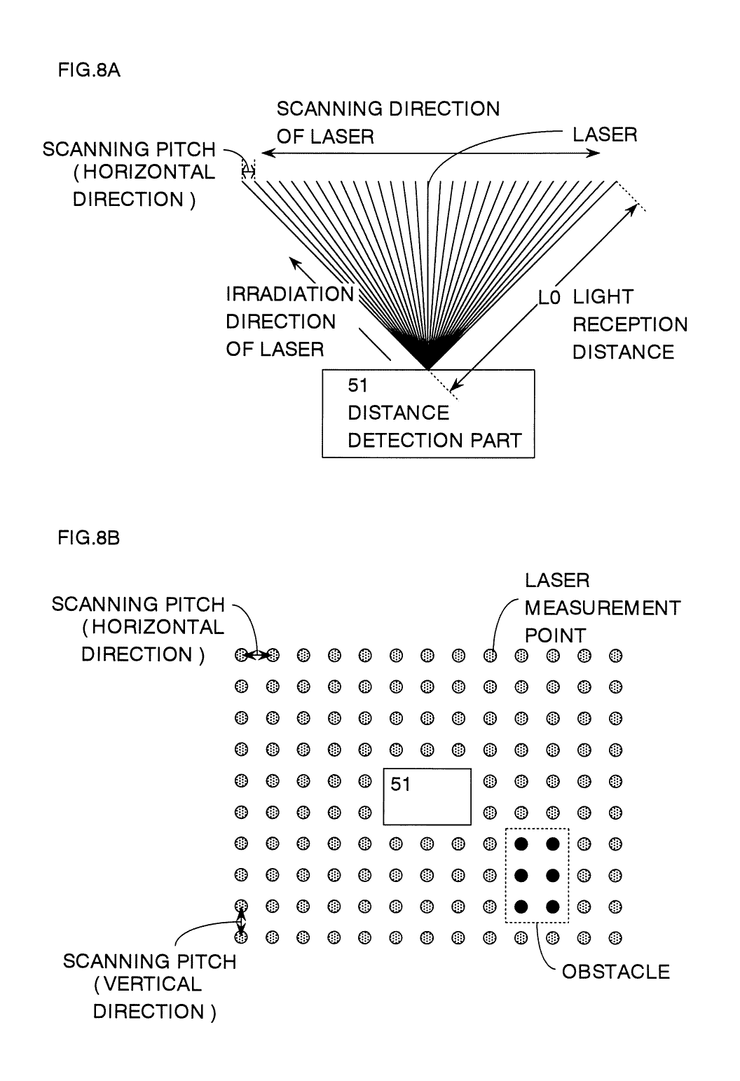

FIGS. 8A and 8B are diagrams in which an irradiation area of the laser emitted from the distance detection part (LIDAR) 51 is viewed from above (FIG. 8A) and from back (FIG. 8B).

In FIG. 7, each point illustrates a point on which the laser hits in a vertical two-dimensional plane (vertical plane) at a location separated by a predetermined distance (hereinafter, such a point is referred to as a measurement point).

For example, when the direction of the distance detection part 51 is changed such that the emitting direction of the laser emitted from the light emitting part 51a of the distance detection part 51 horizontally moves right by a predetermined scanning pitch, the laser hits on the vertical plane at a next location (measurement point) horizontally deviated right by the scanning pitch.

If any object exists at this location on the vertical plane, a part of reflected light of each of lasers reflected on the respective measurement points is received by the light receiving part 51b.

Thus, when an irradiation direction of the laser is sequentially horizontally deviated by the predetermined scanning pitch, a laser is applied to a predetermined number of the measurement points. Presence/absence of reception of reflected light is confirmed for each of the plurality of measurement points to which the laser is applied, and a distance is calculated.

FIG. 8A is an explanatory diagram of an example of performing laser scanning in the right and left direction (namely, the horizontal direction) of the drawing while the irradiation direction of the laser is deviated by a horizontal scanning pitch.

For example, as illustrated in FIG. 8A, in a case where the laser is applied in a rightmost direction, when an object exists in this direction, light reception distance L0 is calculated by receiving reflected light from the object.

As illustrated in FIG. 7, in a case where a laser-scanning direction is set to the vertical direction, for example, when a laser-emitting direction is deviated vertically upward by a predetermined scanning pitch, the laser hits on a vertical plane at a next location (measurement point) deviated vertically upward by the scanning pitch.

When the laser-emitting direction is deviated vertically upward by one scanning pitch, and thereafter the laser irradiation direction is deviated horizontally as illustrated in FIG. 8A, the laser is applied to a measurement point at a location deviated upward with respect to a previous measurement point by one scanning pitch.

Thus, horizontal laser scanning and vertical laser scanning are sequentially performed, so that the laser is applied to a predetermined three-dimensional space. Then, when an object exists in a three-dimensional measurement space, a distance to the object is calculated.

In a case where the light (laser) emitted toward the plurality of measurement points is reflected on an object, when it is confirmed that reflected light reflected on the object is received by the light receiving part, it is determined that a part of the object exists at a location of the measurement points used for calculating the distance.

Furthermore, the object exists in an area including the plurality of measurement points where it is determined that the part of the object exists. Detection information for characterizing a shape of an object or posture of a human body is acquired from information of the area including the plurality of measurement points.

The detection information is some pieces of information for characterizing an object, and may be acquired by the distance detection part 51, or may be acquired from image data of an object photographed by the camera 55.

In the two-dimensional scanning, the laser-scanning direction is set to the horizontal direction in the description. However, the laser-scanning direction is not limited to this, and may be changed to the vertical direction.

In a case where a laser is applied to a three-dimensional measurement space, after vertical two-dimensional scanning is performed, the laser scanning direction may be horizontally deviated by the predetermined scanning pitch, and similar vertical two-dimensional scanning may be sequentially performed.

FIG. 8B is a schematic explanatory diagram of measurement points of the laser applied to the three-dimensional space in a case where laser scanning is performed in the horizontal direction and in the vertical direction.

If no object exists in a direction of one of the measurement points to which the laser is emitted, the laser advances on an optical path, reflected light is not received, and a distance cannot be measured.

On the other hand, if reflected light derived from a laser emitted to a certain measurement point is received, a distance is calculated, and it is recognized that an object exists at a location separated by the calculated distance.

FIG. 8B illustrates a situation where reflected light is detected at six measurement points in a lower right part, and it is recognized that some object (e.g., a human body or an obstacle) exists in an area including these six measurement points.

When a laser 51d enters the light receiving part 51b of the distance detection part 51, an electric signal corresponding to received light intensity of the laser is output.

The controller 50 confirms the electric signal output from the light receiving part 51b. For example, in a case where an electric signal having an intensity equal to or higher than a predetermined threshold is detected, it is determined that the laser is received.

A laser emitting element that is conventionally used is used for the light emitting part 51a, and a laser receiving element that detects a laser is used for the light receiving part 51b.

The controller 50 calculates a light reception distance L0 that is a distance between the light emitting part 51a and each of the plurality of measurement points by utilizing a time difference T0 between an emitting time of a laser emitted from the light emitting part 51a, and a light receiving time when it is confirmed that reflected light is received by the light receiving part 51b.

The controller 50 acquires a current time by utilizing, for example, a timer, calculates the time difference T0 between the laser emitting time and the light receiving time when the reception of the laser is confirmed, and calculates the light reception distance L0 by utilizing the time difference T0 between both the above times, and a speed of the laser.

The traveling control part 52 is a part that controls driving members, mainly controls rotation of the wheels 57 corresponding to the driving members, and causes the wheels 57 to perform linear traveling, rotation operation, and the like, so that it causes the vehicle to automatically travel. The driving members include wheels, a caterpillar, and the like.

The wheels 53 correspond to the four wheels (21, 22, 31, 32) illustrated in FIG. 1, and FIGS. 2A and 2B.

As described above, among the wheels, the right and left front wheels (21, 31) may be driving wheels, and the right and left rear wheels (22, 32) may be driven wheels for which rotation control is not performed.

Additionally, traveling may be controlled by respectively providing encoders (not illustrated) in the left wheel and the right wheel of the driving wheels (21, 31), and measuring a moving distance and the like of the vehicle by the numbers of rotations, rotation directions, rotation locations, and rotation speeds of the wheels.

The communication part 54 is a part that transmits/receives data to/from the management server 5 through the network 6. As described above, the communication part 54 is preferably connected to the network 6 by wireless communication, and has a function that it is capable of communicating with the management server 5.

As described later, in a case where a notification process is executed as operation in emergency, the communication part 54 transmits, for example, notification information including occurrence of an abnormal state, an occurrence date and time of the abnormal state, and an occurrence location of the abnormal state, to the management server 5 disposed at a different location from the autonomous traveling apparatus.

Additionally, the notification information may be transmitted to a terminal possessed by a person in charge at a location different from a location of the autonomous traveling apparatus. The notification information should be transmitted to at least one of the management server and the terminal.

It is necessary to previously set a destination, but the destination may be changed or added based on a content of the abnormal state, corresponding to an operation form of the vehicle.

The camera 55 is a part that mainly photographs an image of a predetermined space including a front space in a traveling direction of a vehicle, and the image to be photographed may be a still image or a moving image. The photographed image is stored in the storage part 70, as input image data 71, and is forwarded to the management server 5 in response to a request from the management server.

A plurality of the cameras 55 may be provided. Four cameras may be fixed and installed so as to photograph, for example, front, left, right, and rear of the vehicle body, or may be configured to change a photographing direction of each camera. The camera 55 may have a zoom function.

In a case where the vehicle travels outdoors, when weather is good, and an area to be photographed is sufficiently bright, an image photographed by the camera is analyzed, so that states and the like of a human body, an obstacle, and a road surface are detected.

As described later, particularly in a case where the image recognition part 56 recognizes that the object photographed by the camera is a human body, the image recognition part 56 furthermore determines whether or not the human body can coincide with person registration information 72 previously stored in the storage part 70, and executes predetermined operation in emergency among an intimidation process, a saving process, and the like, based on a result of the determination.

The image recognition part 56 is a part that recognizes an object included in image data (input image data 71) photographed by the camera 55. Particularly, in a case where the image recognition part 56 extracts an object included in the image data, and the extracted object is an object having a predetermined characteristic of a human body, the image recognition part 56 recognizes the object as a human body. Furthermore, the image recognition part 56 compares image data (human body image) of a part of the recognized human body, with the person registration information 72 previously stored in the storage part 70, and determines whether or not the human body image can coincide with a previously registered person. An image recognition process may be performed by using an existing image recognition technique.

When there is a part that is a characteristic of a human body (e.g., a head, a face, a neck, or a foot) in the input image data 71 photographed by the camera 55, the image recognition part 56 recognizes the part as a human body. Furthermore, the image recognition part 56 extracts image data of a part of the recognized human body, and collates the extracted image data with the person registration information 72 previously stored in the storage part 70.

The image recognition part 56 compares a face part of the image data of the extracted human body with a face part of the person registration information 72 by mainly utilizing a currently used face recognition technique, and determines whether or not both the face parts can coincide with each other. In a case where both the face parts can coincide with each other, the person photographed by the camera is determined to be a previously authenticated (recognized authentic person). In a case where both the face parts do not coincide with each other, the person is determined to be a suspicious person.

Alternatively, in a case where there is no part corresponding to a human body in the photographed image data, a determination that no person is detected is made.

A determination result of this image recognition is used to determine operation in emergency to be executed, as described later.

For example, in a case where the recognized human body image does not coincide with the previously stored person registration information 72, an intimidation process of outputting a warning to the photographed human body is executed as the operation in emergency, and furthermore, a notification process of notifying the person in charge at the location different from a location of the autonomous traveling apparatus that an abnormal state occurs is executed.

The vibration detection part 57 is a part that detects vibration externally applied to the autonomous traveling apparatus 1, and mainly detects externally applied vibration during stoppage of the autonomous traveling apparatus 1.

The vibration detection part 57 corresponds to a sensor for preventing theft. As the sensor for preventing theft, other than the vibration detection part 57, for example, a tilt sensor for sensing the tile of the vehicle, a sound sensor for sensing the sound only of a predetermined frequency range, or a distance detection part such as a field sensor, LIDAR for sensing abnormal approach to the vehicle by waves, or the like are available.

Additionally, the vibration detection part 57 may detect vibration other than vibration generated during traveling. For example, vibration generated when the vehicle is lifted, vibration generated when the vehicle is subjected to destructive operation, vibration of collision due to a falling object or the like on the vehicle, and the like are preferably detected distinctively.

The vibration detection part 57 may distinctly detect a weak vibration and a strong vibration. When the weak vibration is detected, an intimidation process is executed. When the strong vibration is detected, a saving process is executed.

As a sensor for detecting vibration, for example, any of an acceleration sensor, an angular velocity sensor, a direction sensor, a piezoelectric sensor, and an AE sensor may be used. However, a plurality of these sensors having different functions are preferably combined in order to detect three-dimensional vibration of the vehicle.

For example, vibration generated during traveling can be detected by detecting vertical amplitude or a frequency by use of the angular velocity sensor. Alternatively, vibration generated when the vehicle is destroyed can be detected by detecting an elastic wave by use of the AE sensor.

In a case where the vibration detection part 57 detects vibration when the vehicle is in a stopped state, it is considered that there is a high possibility that an unjustifiable action is performed to the vehicle.

Therefore, operation in emergency to be executed is determined by confirming whether or not vibration is detected, and whether the vibration is temporary or is continued for a certain period or more in addition to a result of the above image recognition, as described later.

The display part 58 is a part that displays predetermined information, and includes a display panel such as an LCD, and a warning lamp including a light emitting source such as an LED. The display part 58 is used to emit a warning (perform intimidation operation) by lighting or flashing light when vibration or a suspicious person is detected, in addition to display of monitoring information for an owner of the vehicle and the like.

The monitoring information acquisition part 59 is a part that acquires information of a predetermined object to be monitored. The monitoring information acquisition part 59 acquires, for example, information collected by autonomous traveling of the vehicle in a predetermined area, or information of a traveling state of the vehicle, and stores the information in the storage part 70 as monitoring information 74. For example, a thermometer, a hygrometer, a microphone, a gas detection apparatus, and/or the like may be provided as a device which corresponds to the monitoring information acquisition part 59.

The monitoring information 74 is information of various objects to be monitored, which is acquired during traveling and during stoppage, and is information transmitted to the management server 5 through the network 6. Examples of this information include input image data 71 photographed by the camera 55, a traveling distance, a movement route, environment data (temperature, humidity, radiation, gas, rainfall, voice, ultraviolet ray, and the like), topographic data, obstacle data, road surface information, and warning information.

The location information acquisition part 60 is a part that acquires information (latitude, longitude, and the like) showing a current location of a vehicle, and may acquire current location information 76 by a GPS (Global Position System), for example.

The location information acquisition part 60 determines a direction in which the vehicle should advance while comparing the acquired current location information 76 with route information 77 previously stored in the storage part 70, so that the vehicle is caused to autonomously travel.

Information obtained from all the distance detection part 51, the camera 55, and the location information acquisition part 60 is preferably used in order to cause the vehicle to autonomously travel. Alternatively, the vehicle may be caused to autonomously travel by utilizing information obtained from at least any one of the distance detection part 51, the camera 55, and the location information acquisition part 60.

As the location information acquisition part 60, any currently utilized satellite positioning system may be used in addition to a GPS. For example, the QZSS (Quasi-Zenith Satellite System) of Japan, the GLONASS (Global Navigation Satellite System) of Russia, the Galileo Navigation Satellite System of EU, the BeiDou Navigation Satellite System of China, or the IRNSS (Indian Regional Navigational Satellite System) of India may be utilized.

The rechargeable battery 61 is a part that supplies power to respective functional elements of the vehicle 1, and mainly supplies power for performing a traveling function, a distance detection function, an image recognition function, a vibration detection function, and a communication function. The rechargeable battery 61 is separated into two parts, namely the main power source 66 and the auxiliary power source 67, as described later.

For example, a rechargeable battery such as a lithium-ion battery, a nickel-metal hydride battery, a Ni—Cd battery, a lead-acid battery, and various fuel cells is used.

The rechargeable battery 61 may include a battery residual amount detecting part (not illustrated), and may detect residual capacity (battery residual amount) of the rechargeable battery, determine based on the detected battery residual amount whether or not it should return to a predetermined charging facility, and automatically return to the charging facility in a case where the battery residual amount is less than a predetermined residual amount.

The information saving part 62 is a part that saves predetermined saving information 75 outside the vehicle 1 in order to put important information among the information stored in the storage part 70 into a safe state. Herein, saving means that the predetermined information is transmitted to an apparatus disposed at a location different from a location of the autonomous traveling apparatus, for example, the management server 5, and furthermore includes erasure of the predetermined information stored in the storage part 70 from the storage part 70.

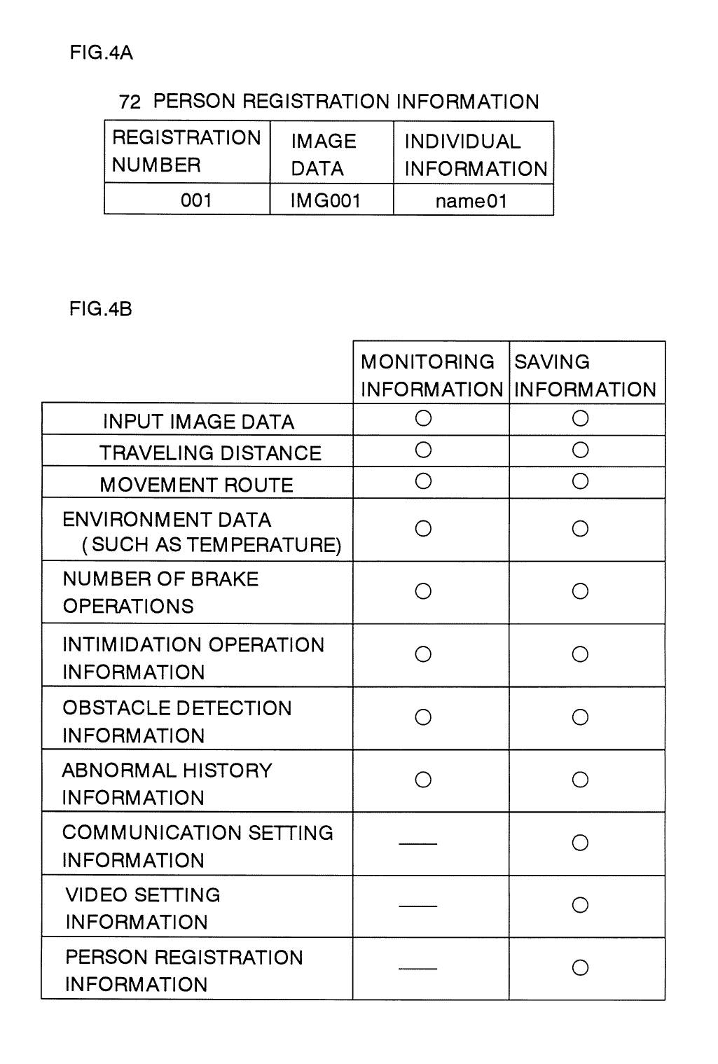

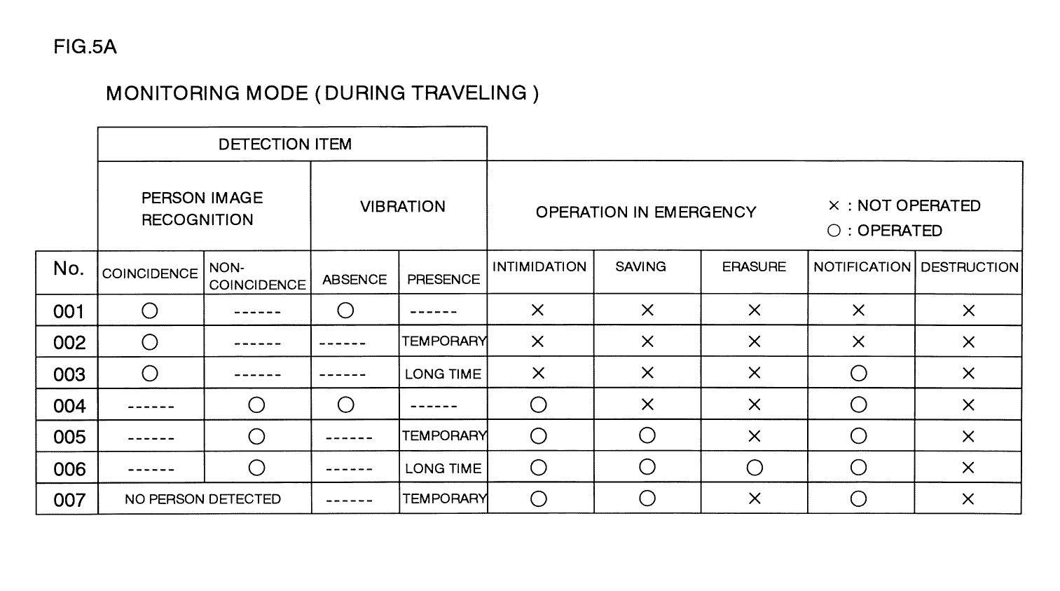

The saving information 75 means information desired to be prevented from being stolen and fraudulently used, and includes setting information necessary for executing a predetermined function, such as communication setting information, video setting information, and person registration information as illustrated in FIG. 4B described later, in addition to the monitoring information 74 acquired from an object to be monitored as described above.

In a case where a predetermined condition is satisfied based on the results of the image recognition and the vibration detection as described above, information is saved. For example, in a case where presence of a suspicious person is recognized in the photographed input image data, and it is detected that vibration is temporarily applied to the vehicle during stoppage, the predetermined saving information 75 stored in the storage part 70 of the vehicle is transmitted to the management server 5.

The intimidation execution part 63 is a part that performs an intimidation process to a suspicious person or the like, and mainly outputs predetermined alarm sound or alarm light by utilizing sound and light. For example, in a case where the intimidation execution part 63 includes the speaker 65, and recognizes that a suspicious person is present, the intimidation execution part 63 outputs predetermined siren sound or voice message of warning from the speaker 65. Additionally, the intimidation execution part 63 flashes a warning lamp or displays a warning message on a display screen.

The power control part 64 is a part that controls power supplied in order to operate each piece of hardware of the autonomous traveling apparatus 1, and that activates and stops the main power source 66 and the auxiliary power source 67, and switches between the main power source 66 and the auxiliary power source 67.

For example, each piece of hardware is operated by power supplied from the main power source 66 during traveling (in a monitoring mode described later) of the autonomous traveling apparatus 1, while a power source that supplies power is switched from the main power source 66 to the auxiliary power source 67, and only main components are operated by power supplied from the auxiliary power source 67 during stoppage of the traveling (in a standby mode described later).

The main power source 66 is a part that supplies power for operating all of hardware of the autonomous traveling apparatus 1 in the rechargeable battery 61.

The auxiliary power source 67 is a rechargeable battery that is different from a rechargeable battery serving as the main power source 66, and is housed in a housing different from a housing that houses the main power source 66, such that the main components can be operated even if the main power source 66 is destroyed. Additionally, the auxiliary power source 67 is always charged during operation of the main power source 66. In addition to a time during stoppage of the traveling, the auxiliary power source 67 supplies power to the main components in place of the main power source 66 also in a case where a residual capacity of the main power source 66 reduces to a predetermined amount or less, or in a case where the main power source stops output.

The main components are parts including, for example, the controller 50, the image recognition part 56, the vibration detection part 57, the communication part 54, the information saving part 62, and the storage part 70.

The storage part 70 is a part that stores information and a program necessary for executing respective functions of the autonomous traveling apparatus 1, and a semiconductor memory such as a ROM, a RAM and a flash memory, a storage apparatus such as an HDD and an SSD, and other storage media are used for the storage part 70. The storage part 70 stores, for example, the input image data 71, the person registration information 72, the measurement distance information 73, the monitoring information 74, the saving information 75, the current location information 76, and the route information 77.

The input image data 71 is image data photographed by the camera 55. In a case where there are a plurality of cameras, the input image data 71 is stored in each camera. As the image data, either of a still image and a moving image may be used. The image data is utilized to detect a suspicious person, detect an abnormal state, and determine a course of the vehicle, and is transmitted to the management server 5, as one of pieces of the monitoring information 74.

The person registration information 72 is information storing images of a plurality of specific persons, and previously stored in the storage part 70. For example, image data of authentic persons such as a person in charge of monitoring, and a person in charge of maintenance of a vehicle may be previously registered. Additionally, image data of composite sketches of wanted criminals may be previously stored. The person registration information 72 is used to determine whether a photographed person is a recognized authentic person or a suspicious person in the image recognition process.

The measurement distance information 73 is light reception distances L0 calculated by the information acquired from the distance detection part 51 as described above. One light reception distance L0 means a distance measured at one measurement point in a predetermined distance measurement area.

This information 73 is stored for each measurement point that belongs to the predetermined distance measurement area, and stored in association with location information of each measurement point. For example, in a case where the number of measurement points is m in the horizontal direction, and the number of measurement points is n in the vertical direction, a light reception distance L0 corresponding to each of a total of (m×n) measurement points is stored.

In a case where an object (an obstacle, a road surface, a pole, or the like) that reflects a laser exists in a direction of each measurement point and reflected light from the object is received, a light reception distance L0 to the object is stored. However, in a case where no object exists in the direction of each measurement point, the reflected light is not received, and therefore, for example, information showing that measurement is not possible may be stored as the measurement distance information 73 in place of the light reception distance L0.

The current location information 76 is information for showing a current location of the vehicle acquired by the location information acquisition part 60. For example, the current location information 76 is information of a latitude and a longitude acquired by utilizing a GPS. This information is used, for example, to determine a course of the vehicle.

The route information 77 previously stores a map of a route where the vehicle is to travel. For example, in a case where a movement route or area is previously fixedly determined, the route information 77 is stored as fixed information from beginning. However, for example, in a case where route change is necessary, information transmitted from the management server 5 through the network 6 may be stored as new route information.

FIGS. 4A and 4B each illustrate an explanatory diagram of an embodiment of the information stored in the storage part.

FIG. 4A illustrates an embodiment of the person registration information 72. Herein, the person registration information 72 includes registration number, image data, and individual information.

The registration number is a recognition number for distinguishing a plurality of pieces of image data. The image data may be a photograph, or may be an identification photograph including a face so as to enable a face recognition process. The individual information is information capable of identifying a person that appears in the image data, and includes, for example, name, age, sex, address, telephone number, company name, and department to which the person belongs.

FIG. 4B illustrates an embodiment of the monitoring information 74 and the saving information 75 stored in the storage part 70.

The monitoring information 74 is information from input image data to abnormal history information, and stored along with the acquired date information and location information.

The input image data 71 is the still image or the moving image acquired from the camera 55, as described above. In a case where a plurality of cameras are provided, the input image data 71 is stored in each camera.

A traveling distance and the number of brake operations are information related to a vehicle and a traveling situation, and mainly used in maintenance of the vehicle. Examples of the information used in maintenance include location information by a GPS, the numbers of lighting/unlighting operation of a light and a warning lamp, and the number of operation of a siren, in addition to the above information.

The information related to an area where a vehicle travels includes information (size, location, and the like) of an obstacle detected by using environment data such as a temperature as described above, a bumper, a LIDAR and an ultrasonic wave sensor.

Furthermore, an abnormal state that occurs during monitoring and traveling, and a history of intimidation operation to a suspicious person are also stored, including an occurrence date and time, and an occurrence location of the abnormal state, and a content of the abnormal state, as the monitoring information 74.

The monitoring information 74 is not limited to the information illustrated in FIG. 4B, and desired information may be added or deleted as necessary. Items of monitoring information to be stored can be changed on a case-by-case basis by setting input manipulation by a person in charge.

The saving information 75 is information that is transmitted to the management server 5 or is erased in a case where there is a fear of destruction or fraudulent leakage of the information stored in the storage part 70. The saving information 75 also includes information previously stored in the storage part 70 in addition to the monitoring information 74, as illustrated in FIG. 4B.

Examples of the previously stored information include the communication setting information, the video setting information, and the person registration information 72.

Herein, the communication setting information includes information (ID, password, and the like) necessary for connection with a management server, communication means, and authentication information.

Video setting information includes information (password, IP address, and the like) for accessing to a camera, and command information for controlling an autofocus function and direction change of a camera.

Similarly, the saving information 75 is not limited to the information illustrated in FIG. 4B, and desired information may be added or deleted as necessary.

Additionally, information to be saved may be selected on a case-by-case basis by setting manipulation by a person in charge, and ranking (priority) transmitted to the management server may be given to each piece of saving information.

### <Description of Operation in Emergency When Abnormal State is Detected>

The following description covers operation in emergency to be performed in a case where the autonomous traveling apparatus detects occurrence of an abnormal state. Herein, examples of an assumed abnormal state include an abnormal state of the autonomous traveling apparatus itself, and an abnormal state of an area or a building that is being monitored. For example, the following states are possible:

(1) a case where a suspicious person is detected;

(2) a case where a suspicious person comes close to a vehicle;

(3) a case where a suspicious person temporarily applies vibration to a vehicle;

(4) a case where a suspicious person continuously applies vibration (long-time vibration) to a vehicle;

(5) a case where a suspicious person is not detected, but vibration is applied to a vehicle,

(6) a case where a fire, a suspicious object, deterioration or damage of a building or the like is detected in a monitoring area; and

(7) a case where an object falls on a vehicle from above.

However, the abnormal state is not limited to the above states, and may be changed, added, or deleted in accordance with a situation where the vehicle is used.

On the other hand, a case where it is determined by the image recognition that a person who comes close to a vehicle is any of recognized authentic persons which has been previously registered, or a case where the recognized authentic person applies vibration to the vehicle is not included in the abnormal state.

Presence/absence of the abnormal state described above is determined by an image photographed by the camera 55, and vibration detected by the vibration detection part 57. In order to detect effective vibration, in a case where presence of a person is recognized, presence/absence of vibration is preferably detected after traveling is stopped.

In a case where any of the abnormal states is detected, the operation in emergency previously associated with each abnormal state is executed. Examples of the operation in emergency include an intimidation process, an information saving process, an information erasure process, a notification process of an abnormal state and the like, and a destruction process of main components of a vehicle.

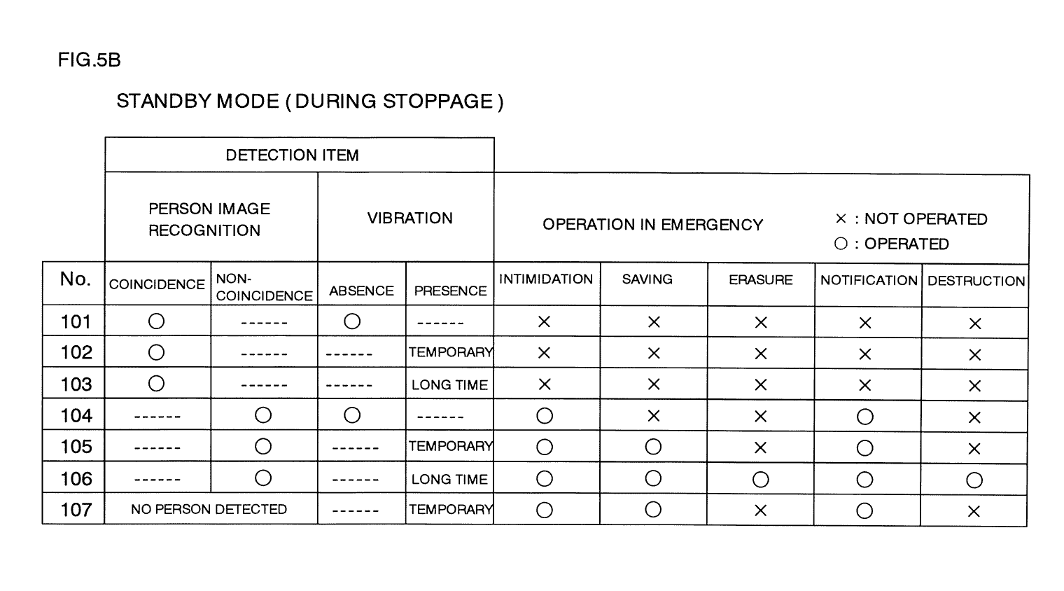

FIGS. 5A and 5B each are an explanatory diagram of an embodiment of detection items of the abnormal state, and the operation in emergency. Herein, the detection items include “person image recognition” and “vibration.”

The “person image recognition” includes a case where an image coincides with the person registration information 72, a case where an image does not coincide with the person registration information 72, and a state where no person is detected.

The “vibration” includes a state where vibration is not detected, a state where temporary (e.g., within 30 seconds) vibration is detected, and a state where vibration is continuously detected for a long time (e.g., 5 minutes or more).

In the following embodiments, it is assumed that any of the above five processes is executed as the operation in emergency.

Additionally, it is assumed that the autonomous traveling apparatus 1 has two operation modes, specifically, a “monitoring mode” and a “standby mode.”

The monitoring mode means a state where a vehicle autonomously travels while collecting the monitoring information 74 such as image data, based on predetermined route information 77.

The standby mode means a mode other than the monitoring mode, and corresponds to, for example, a stopped state where the vehicle is being charged after returning to a charging facility, and a stopped state where the main power source is turned off and power from the auxiliary power source alone is supplied to predetermined components.

### First Embodiment

FIG. 5A is an explanatory diagram of an embodiment of detection items and operation in emergency in a monitoring mode. It is assumed that, in a case where respective states of the two detection items on a left side of FIG. 5A are established, the operation in emergency marked by a mark “∘” on a right side is executed.

Herein, “coincidence” in person image recognition means that a human body existed in input image data 71 photographed by a camera, and image data of the human body was capable of coinciding with any of pieces of person registration information 72 previously stored in a storage part 70.

Additionally, “non-coincidence” means that image data which can coincide with an image of the human body included in the photographed input image data 71 did not exist in the person registration information 72. Additionally, “no person detected” means that there is no object that can be recognized as a human body, in the input image data 71.

In FIG. 5A, for example, in No. 001, a case where a result of the person image recognition is “coincidence,” and vibration is not detected is shown. In this case, none of five kinds of the operation in emergency is executed. That is, the camera detects that a person is present near the vehicle, but in a case where the person is any of the recognized authentic persons who are previously registered, it is determined that this case is not in an abnormal state, and no operation in emergency is performed.

Next, in No. 002, a case where a result of the person image recognition is “coincidence,” and vibration is “temporary” is shown. In this case, it is considered that any of the recognized authentic persons who are previously registered applies temporary vibration, and therefore it is determined that this case is not in an abnormal state, and no operation in emergency is performed similarly to the case of No. 001. However, although not illustrated, the communication part 54 may notify the management server 5 that any of the recognized authentic persons who are registered applies the vibration.

In No. 003, a case where a result of the person image recognition is “coincidence,” but vibration is applied for a “long time” is shown. In this case, it is determined that this case is not an abnormal state similarly to the case of No. 002, but the communication part 54 notifies the management server 5 that the vibration is applied for a long time. However, it is considered that the vibration is long time vibration applied by any of the recognized authentic persons, and therefore the notification process does not have to be performed.

For example, a fact that the long time vibration is applied may be notified, including name (ID) of the recognized authentic person who applied vibration, current image data of the recognized authentic person, date information of the application of the vibration, and location information of the vehicle. It is considered that this case is not in an abnormal state, and therefore any other operation in emergency (intimidation, saving, erasure, or destruction) is not performed.

In No. 004, a case where a result of the person image recognition is “non-coincidence,” but no vibration is applied to the vehicle is shown. In this case, it is determined that this case is in an abnormal state where a suspicious person who is not registered is present near the vehicle.

In this state, although the suspicious person is found, it is considered that no fraudulent action is performed to the vehicle yet, and therefore the intimidation process is executed as the operation in emergency in order to prevent theft or the like beforehand. For example, output of a warning by siren or voice, flashing display of a warning lamp, or the like is performed.

Additionally, the communication part 54 notifies the management server 5 that an abnormal state occurs. For example, a fact that a suspicious person is found, image data of the suspicious person, an occurrence date and time of the abnormal state, and an occurrence place of the abnormal state are transmitted to the management server 5.

In No. 005, a case where a result of the person image recognition is “non-coincidence,” and temporary vibration is externally applied to the vehicle is shown. It is considered that a suspicious person tries to perform some fraudulent action to the vehicle, and it is determined that this case is in an abnormal state. In this case, a fraudulent action such as extraction or destruction of data is sometimes being already performed, and therefore the saving process of the saving information 75 stored in the storage part is executed as the operation in emergency, in addition to the above intimidation process.

For example, the saving information 75 illustrated in FIG. 4B is transmitted to the management server 5 disposed at a location different from a location of the autonomous traveling apparatus. Additionally, in a case where priority is given to the saving information 75, high priority information is first transmitted to the management server 5.

However, the vibration is temporarily applied only for a short time, and therefore the information stored in the storage part 70 is not erased.

In this case, the notification process of transmitting occurrence of an abnormal state to the management server 5 is also executed. For example, a fact that the suspicious person tries to temporarily perform the fraudulent action, image data of the suspicious person, a level of the vibration, an occurrence date and time of the abnormal state, and an occurrence place of the abnormal state are transmitted to the management server 5.

In No. 006, a case where a result of the person image recognition is “non-coincidence,” and detected vibration is long time vibration continuously applied for a certain period or more is shown. In this case, it is considered that a fraudulent action by a suspicious person is executed, and therefore it is determined that this case is in an abnormal state.

In this case, it is considered that there is a possibility that the information stored in the storage part 70 is stolen or destroyed. Therefore, an erasure process of erasing the saving information 75 stored in the storage part 70 is executed in addition to the above intimidation process, saving process, and notification process. The erasure process is executed after the saving process.

The information is erased, so that theft or destruction of importance information like the important information illustrated in FIG. 4B is prevented. Additionally, as the notification process, a fact that the fraudulent action is performed for a long time by the suspicious person, image data of the suspicious person, erasure of the information stored in the storage part 70, an occurrence date and time of the abnormal state, and an occurrence location of the abnormal state should be transmitted to the management server 5.

In No. 007, a case where a result of the person image recognition is “no person detected,” but temporary vibration is detected is shown. In this case, no suspicious person is present, but it is considered that there is a fear that some attack is made from a remote place, and it is determined that this case is in an abnormal state.

In this case, for example, the intimidation process, the saving process, and the notification process are executed as the operation in emergency. Herein, a fact that no suspicious person is found, a fact that the temporary vibration is applied, an occurrence date and time of the abnormal state, and an occurrence location of the abnormal state should be transmitted to the management server 5.

Thus, several kinds of the operation in emergency in the seven detected states in the monitoring mode have been described. However, the present invention is not limited to these detected states and these kinds of operation in emergency. Items other than the two detection items may be utilized, and other detection conditions may be set. Additionally, operation in emergency to be executed may be added or changed, for example, corresponding to a monitoring situation of an area where the vehicle travels.

### Second Embodiment

FIG. 5B is an explanatory diagram of an embodiment of detection items and operation in emergency in a standby mode.

Herein, it is assumed that, in the standby mode, the vehicle does not travel, the main power source is turned off, and power from the auxiliary power source alone is supplied to a predetermined function block.

The detection items identical with the detection items illustrated in FIG. 5A are shown.

However, in a case where the power from the auxiliary power source is not supplied to the camera 55, image data cannot be acquired by the camera. Therefore, image recognition of a person cannot be performed. In this case, “person image recognition” may be deleted from the detection item, and occurrence of an abnormal state may be determined based only on “vibration” to determine operation in emergency.

In FIG. 5B, No. 101 to No. 105, and No. 107 are the same as in FIG. 5A, and therefore description thereof is omitted.

No. 106 shows a case where vibration is continuously applied for a certain period or more, in a state where the autonomous traveling apparatus is at a stop. In this case, unlike No. 006 of FIG. 5A, as the operation in emergency, a saving process is executed in addition to intimidation, saving, erasure, and notification, and thereafter a destruction process of destroying a predetermined component of the vehicle is performed.

In a case of the standby mode, the destruction process is performed in order to prevent reuse. The component to be destroyed is, for example, a component (a storage part, a camera, a substrate, or the like) desired to be prevented from being reused after theft, or a main power source, but is not particularly limited.

As a destruction method, for example, a high voltage exceeding a standard may be applied to an electric circuit of the predetermined component to be destroyed, or an electric polarity to be applied may be reversely connected.

Thus, the intimidation process is executed as the operation in emergency, so that a destruction action and theft of information by a suspicious person can be prevented beforehand.

Additionally, the information saving process is performed, so that the monitoring information and the setting information stored in the storage part 70 are sent to the management server at the location different from a location of the vehicle. Therefore, the monitoring information and the like can be reused and restored, and a situation and the like just before the fraudulent action can be analyzed by using the saved image data and the like.

The monitoring information and the setting information stored in the storage part 70 of the vehicle are erased, so that even when the vehicle is stolen, the monitoring information and the like can be prevented from being fraudulently used, and it is possible to prevent leakage of stored important secret information and the like.

For example, when an abnormal state occurs, information showing the abnormal state is notified to the management server 5 by using the communication part 54. Thereby, a situation of the vehicle can be quickly notified to a person in charge of the management server, and the person can promptly take a countermeasure, such as sending of a guard to a current place where the vehicle travels.

### Other Embodiments

### Third Embodiment

In each of the above embodiments, in a case the abnormal state occurs, the intimidation process and the like are performed, and the notification process of notifying the current situation of the vehicle to the management server 5 is performed. However, a destination of notification is not limited to the management server 5.

For example, the current situation may be notified to a guard located at a current place where the vehicle travels, a serviceman of a maintenance company, or the like. In this case, alarm information is preferably transmitted to a portable terminal possessed by the guard or the like in a form that the information can be easily noticed and seen by the guard at any time.

The abnormal state is notified to the guard who is near the vehicle, so that a suspicious person can be promptly found or captured, and the fraudulent action such as theft can be prevented beforehand.

### Fourth Embodiment

The embodiment, in which the predetermined component of the vehicle is destroyed in the case where an abnormal state occurs, has been described. As the destruction method, the following methods can be mentioned. The methods each are executed as an automatic process of the vehicle.

(1) A high voltage exceeding a standard is applied or a voltage having a reverse polarity is applied.

(2) A memory, a camera, and the like are physically destroyed by an apparatus for destruction which is previously provided.

(3) Physical destruction is performed by remote operation.

(4) A destruction apparatus including built-in battery and timer is previously provided, and timed destruction is performed by activating the timer of the destruction apparatus when a destruction process is executed.

### Fifth Embodiment

In each of the above embodiments, the information saving process and the notification process to the management server are performed. However, before the saving process or the notification process is executed, it is necessary to prevent a suspicious person from performing theft or destruction in a short time.

In order to prevent theft or a destruction action until saving or notification of information is completed, and in order to delay the action such as theft as much as possible, important components such as the auxiliary power source, the controller, the communication part, and the storage part are preferably housed in a sealed container that cannot be easily destroyed or allowing contents to be taken out. For example, the important components may be housed in a container of duralumin, carbon fiber or the like, or a reinforced housing covered with tempered glass (bulletproof glass) or the like.

### Sixth Embodiment

In each of the above embodiments, the images of the recognized authentic persons that are authentic persons are previously stored in the storage part 70 as the person registration information 72. However, in a case where there is image data that enables identification of a suspicious person, a person who has committed a crime, or/and the like, such image data may be stored in the storage part 70 as suspicious person image information, separately from the image data of the recognized authentic person.

In this case, image data photographed by the camera is compared with this suspicious person image information. In a case where data that can coincide with a person included in photographed image data exists in the suspicious person image information, the person photographed by the camera is to be positively determined as the suspicious person.

According to the present invention, operation in emergency corresponding to a recognition result of an image and a detection result of vibration is executed, and therefore a suitable process corresponding to an abnormal state which has occurred can be promptly executed, and it is possible reduce a risk of a fraudulent action such as theft and destruction of an autonomous traveling apparatus, and leakage of secret information.

1. An autonomous traveling apparatus comprising:
a traveling control part for controlling a driving member;
an imaging part for photographing an image data of a predetermined external space;
an image recognition part for extracting a human body included in the image data photographed by the imaging part, and recognizing an image data of the extracted human body;
a sensor for preventing theft; and
a controller for executing operation in emergency corresponding to a recognition result by the image recognition part, and a detection result by the sensor for preventing theft.

2. The autonomous traveling apparatus according to claim 1, wherein the sensor for preventing theft comprises a vibration detection part for detecting externally applied vibration.

3. The autonomous traveling apparatus according to claim 2, further comprising a storage part, wherein
person registration information in which image data of an authentic person is registered is previously stored in the storage part, and
in a case where the image recognition part compares a human body image included in the image data photographed by the imaging part with the person registration information stored in the storage part, and the human body image and the person registration information do not coincide with each other,
the controller executes an intimidation process of outputting a warning to the photographed human body, as the operation in emergency, and executes a notification process of notifying a person in charge at a location different from a location of the autonomous traveling apparatus that an abnormal state occurs.

4. The autonomous traveling apparatus according to claim 3, further comprising a monitoring information acquisition part for acquiring information of a predetermined object to be monitored, wherein
saving information including monitoring information acquired from the object to be monitored, and setting information necessary for executing a predetermined function, is stored in the storage part, and
in a case where the image data that is capable of coinciding with the human body image included in the photographed image data does not exist in the person registration information stored in the storage part, and the vibration detection part detects that vibration is externally applied,
the controller executes the intimidation process, the notification process, and a saving process of transmitting the saving information stored in the storage part to a management server disposed at a location different from a location of the autonomous traveling apparatus, as the operation in emergency.

5. The autonomous traveling apparatus according to claim 4, wherein
in a case where the vibration detection part detects that vibration is continuously applied for a certain period or more,
the controller executes the intimidation process, the notification process, the saving process, and an erasure process of erasing the saving information stored in the storage part, as the operation in emergency.

6. The autonomous traveling apparatus according to claim 5, wherein
in a case where the vibration detection part detects that vibration is continuously applied for a certain period or more in a state where the autonomous traveling apparatus is at a stop,
the controller executes a destruction process of destroying a predetermined component of the autonomous traveling apparatus, after executing the saving process.

7. The autonomous traveling apparatus according to claim 3, further comprising a communication part that performs wireless communication through a network, wherein
in a case where the notification process is executed, the communication part transmits notification information including occurrence of the abnormal state, an occurrence date, and an occurrence location, to at least one of a management server disposed at a location different from a location of the autonomous traveling apparatus and a terminal possessed by the person in charge or to both of them.

8. The autonomous traveling apparatus according to claim 4, wherein the vibration detection part distinctly detects a weak vibration, by which detection the intimidation process is executed, and a strong vibration, by which detection the saving process is executed.

9. The autonomous traveling apparatus according to claim 1, wherein the sensor for preventing theft comprises a distance detection part for emitting laser three-dimensionally.
